(19) United States
(12) Patent Application Publication
(10) Pub. No.: US 2009/0072648 A1
(43) Pub. Date: Mar. 19, 2009

(54) OUTWARD TURNING MOTOR ROTOR FOR A CEILING FAN

(76) Inventor: Mei-Han Li, Taichung City (TW)

Correspondence Address: SINORICA, LLC, 528 FALLSGROVE DRIVE, ROCKVILLE, MD, 20850, US

(21) Appl. No.: 11/856,719

(22) Filed: Sep. 18, 2007

(51) Int. Cl. H02K 1/28; H02K 1/27

(52) U.S. Cl. 310/156.21

(57) ABSTRACT

An outward turning motor rotor for a ceiling fan includes a stator and a rotor positioned around the outer circumference of the stator. The rotor contains a circular-case base having its circumference disposed with a circumferential wall having plural permanent magnets equidistantly and annularly secured thereon. Each permanent magnet has one side facing the stator tapered gradually from an intermediate portion toward a left end and a right end, letting the opposite ends of each permanent magnet respectively formed with a comparatively thin pole portion and lengthening a distance between the pole portions of each permanent magnet and the stator. In change-over motion, a comparatively small magnetic force produced by the pole portions of the rotor will stabilize vibration produced, greatly lowering noises caused by rotation of the rotor.

### BACKGROUND OF THE INVENTION

1. Field of the Invention

This invention relates to an outward turning motor rotor for a ceiling fan, particularly to one having effects of shock absorption and lowering noises.

2. Description of the Prior Art

A conventional ceiling fan motor rotor is installed around the outer circumference of a stator (not shown) and separated from the stator for a proper distance. The conventional ceiling fan motor rotor, as shown in FIG. 1, includes a circular-case base 1 and lots of permanent magnets 2 equidistantly and annularly secured on the inner circumferential wall of the base 1 and integrally curved into an arc-shaped plate with a preset thickness. The rotor is actuated to carry out change-over turning incessantly by action of mutual attraction and mutual repulsion between different magnetic poles produced by adjacent permanent magnets and the stator. However, even volumes of the permanent magnets 2 will produce an integrally even magnetic force; therefore, when carrying out change-over rotating, the rotor will be affected by an attractive force of the permanent magnets 2 to produce a change-over shifting force and cause vibration. Thus, when the ceiling fan motor rotor is operated, it will make noises to influence quality in use of the ceiling fan.

### SUMMARY OF THE INVENTION

This invention is devised to offer an outward turning motor rotor for a ceiling fan, having effects of shock absorption and lowering noises. The outward turning motor rotor includes a stator and a rotor positioned around the outer circumference of the stator. The rotor consists of a circular-case base having its circumference provided with a circumferential wall formed with an accommodating space in the interior. A plurality of permanent magnets are equidistantly and annularly secured on the inner circumferential wall of the base, and each permanent magnet has one side facing to the stator contracted gradually from an intermediate portion toward a left and a right end, letting the opposite ends of each permanent magnet respectively form a comparatively thin pole portion. Thus, magnetic field strength of the opposite ends of each permanent magnet can be lowered, and a distance between the opposite pole portions of the permanent magnet and the stator can be lengthened. By so designing, when the rotor carries out change-over motion, a comparatively small magnetic force produced by the pole portions of the permanent magnets can stabilize vibration produced during performing change-over motion, greatly lowering noises caused by rotation of the rotor.

### BRIEF DESCRIPTION OF DRAWINGS

This invention will be better understood by referring to the accompanying drawings, wherein:

FIG. 1 is a perspective view of a conventional ceiling fan motor rotor;

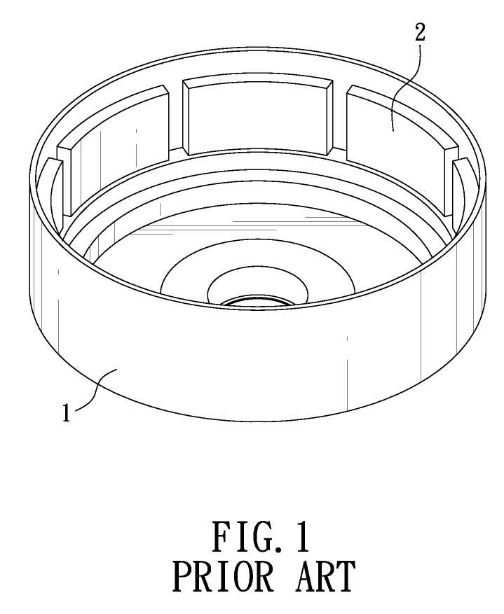

FIG. 2 is an exploded perspective view of a first preferred embodiment of an outward turning motor rotor for a ceiling fan in the present invention;

FIG. 3 is a perspective view of the first preferred embodiment of an outward turning motor rotor for a ceiling fan in the present invention;

FIG. 4 is a cross-sectional view of the first preferred embodiment of an outward turning motor rotor for a ceiling fan in the present invention;

FIG. 5 is a perspective view of a second preferred embodiment of an outward turning motor rotor for a ceiling fan in the present invention; and

FIG. 6 is a cross-sectional view of the second preferred embodiment of an outward tuning motor rotor for a ceiling fan in the present invention.

### DETAILED DESCRIPTION OF THE PREFERRED EMBODIMENT

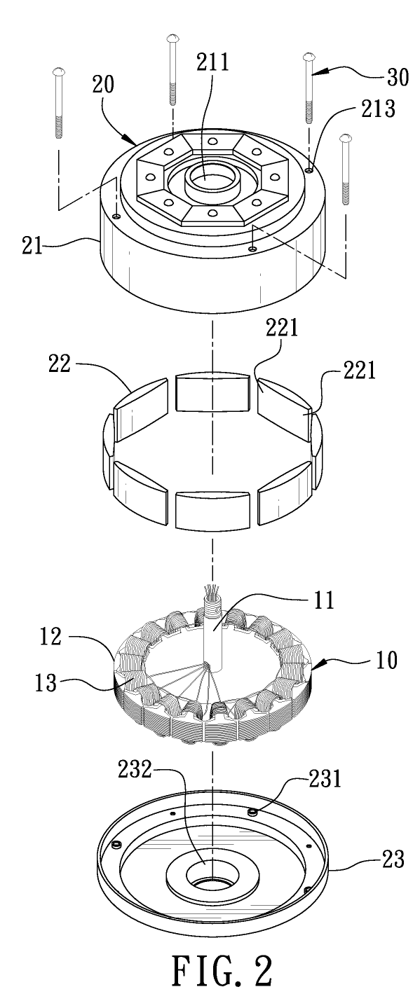

A first preferred embodiment of an outward turning motor rotor for a ceiling fan in the present invention, as shown in FIG. 2, includes a stator 10 and a rotor 20 combined together.

The stator 10 consists of a spindle 11 and an electro-magnet 12. The spindle 11 is inserted through the center of the electro-magnet 12, which is annularly positioned around the spindle 11 and orderly wound thereon with a plurality of coil sets 13.

The rotor 20 is positioned around the outer circumference of the stator 10 and separated from the stator 10 for a proper distance. The rotor 20 is composed of a base 21, a plurality of permanent magnets 22 and a cover 23.

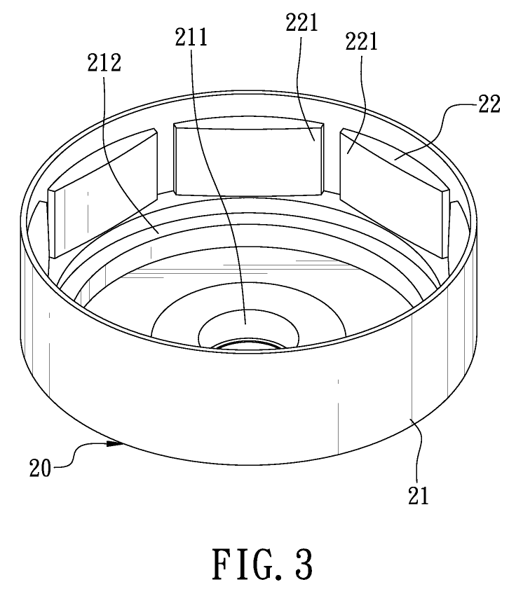

The base 21, referring to FIG. 3, is a circular casing having its center bored with a shaft hole 211 matching with the spindle 11 of the stator 10. The base 21 has its circumference disposed with a circumferential wall formed in the interior with an accommodating space 212 having an opening facing upward. The base 21 further has the underside circumference bored with a plurality of bolt holes 213.

The permanent magnets 22 are equidistantly and annularly secured on the inner circumferential wall of the base 21 by gluing, having a proper distance formed between every two adjacent permanent magnets 22. Each permanent magnet 22 is a rectangular plate with a proper thickness, having its inner side corresponding to the stator 10 curved arcuately and tapered gradually from an intermediate portion to a left and a right end, forming each permanent magnet 22 as an oval shape. Thus, each permanent magnet 22 has its opposite ends respectively formed with a comparatively thin pole portion 221 whose magnetic force is smaller than that of the intermediate portion, and the distance between the pole portions 221 and the outer circumference of the stator 10 is longer than that between the intermediate portion and the outer circumference of the stator 10.

The over 23 to be covered on the opening of the accommodating space 212 of the base 21 has the underside circumference bored with a plurality of threaded holes 231 at locations respectively corresponding to the bolt holes 213 of the base 21, with plural long bolts 30 respectively inserted through the bolt holes 213 of the base 21 and locked in the threaded holes 231 of the cover 23. Further, the cover 23 has its center bored with a shaft hole 232 matching with the spindle 11 of the stator 10.

In assembling of the motor rotor, firstly, the permanent magnets 22 are equidistantly and annularly glued and secured on the inner circumferential wall of the base 21 and then the central spindle 11 of the stator 10 is inserted through the shaft holes 211 and 232 of the base 21 and the cover 23 and secured therein. Subsequently, plural long bolts 30 are respectively inserted through the bolt holes 213 from under the base 21 and firmly engaged with the threaded holes 231 of the cover 23, thus finishing combination of the motor rotor.

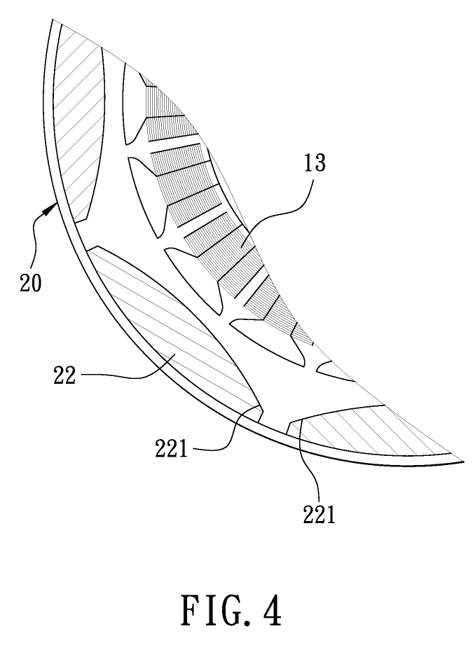

In using, referring to FIG. 4, when the motor rotor 20 is started, the rotor 20 will be actuated to produce change-over motion incessantly by means of action of mutual attraction and mutual repulsion produced between different magnetic poles produced by the pole portions 221 of adjacent permanent magnets 22 and the coil sets 13 wound on the stator 10. Since the magnetic force of the pole portions 221 of the permanent magnets 22 is comparatively small and a distance between the pole portions 221 and the stator 10 is comparatively long; therefore, when the adjacent pole portions of the rotor 20 are rotated relative to the stator 10, its change-over vibration force caused by strong magnetic field produced by the permanent magnets 22 toward the stator 10 will be reduced, thus enabling the rotor 20 to operate smoothly.

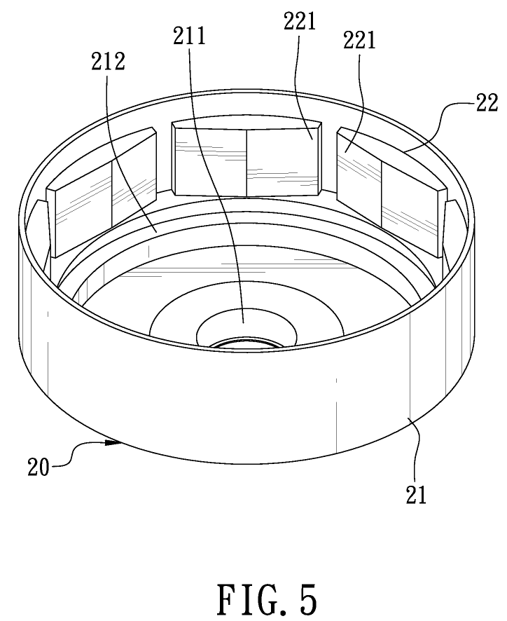

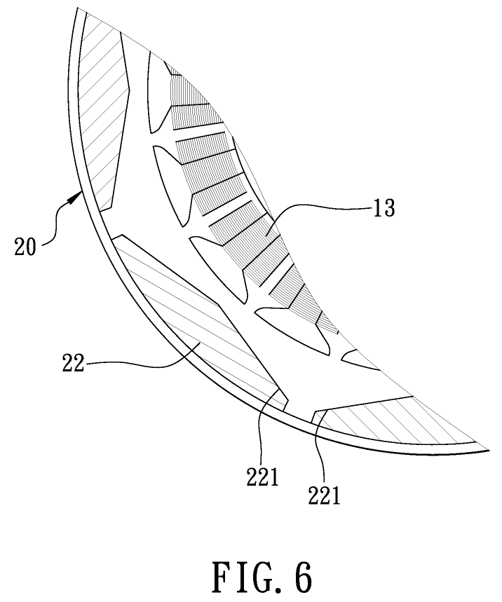

A second preferred embodiment of an outward turning motor rotor for a ceiling fan in the present invention, as shown in FIGS. 5 and 6, has almost the same structure and function as those described in the first preferred embodiment, except that each permanent magnet 22 has its inner side facing to the stator 10 slanting down gradually from an intermediate portion toward a left and a right end to let each permanent magnet 22 shaped as a triangular cone, and its outer side facing the inner circumferential wall of the base 21 formed into an arc-shaped side.

To sum up, each permanent magnet of this invention has its opposite ends respectively formed into a comparatively thin pole portion for lowering magnetic field strength of the opposite ends of the permanent magnet and lengthening the distance between the opposite pole portions of the permanent magnet and the stator. By so designing, when the rotor carries out change-over motion, a comparatively small magnetic force produced by adjacent pole portions can stabilize vibration produced during carrying out the change-over motion to enable the rotor to be operated smoothly and hence lower noises caused by rotation of the rotor, elevating quality in use of the ceiling fan. In addition, the motor rotor of this invention is simple in structure and easy in assembly, having great practicability.

While the preferred embodiments of the invention have been described above, it will be recognized and understood that various modifications may be made therein and the appended claims are intended to cover all such modifications that may fall within the spirit and scope of the invention.

I claim:

1. An outward turning motor rotor for a ceiling fan, said rotor comprising:
a base being a circular casing installed around an outer circumference of a stator and separated from said stator for a proper distance, said base having its circumference disposed with a circumferential wall, said circumferential wall formed with an accommodating space having an opening facing downward;
plural permanent magnets equidistantly and annularly fixed on an inner circumferential wall of said base and respectively forming a plate with a preset thickness, each said permanent magnet having its inner side facing to said stator tapered gradually from an intermediate portion toward a left and a right end, each said permanent magnet having its opposite ends respectively formed with a comparatively thin pole portion; and
a cover secured on an opening of said base.

2. The outward turning motor rotor for a ceiling fan as claimed in claim 1, wherein each said permanent magnet has its inner side facing to said stator curved arcuately and tapered gradually from an intermediate portion toward a left end and a right end to form an oval shape.

3. The outward turning motor rotor for a ceiling fan as claimed in claim 1, wherein each said permanent magnet has its inner side facing to said stator slanting down gradually from an intermediate portion toward a left end and a right end to form a triangular-conical shape and its outer side formed with an arc-shaped side.

4. The outward turning motor rotor for a ceiling fan as claimed in claim 1, wherein said permanent magnets are firmly glued on a circumferential wall of said base.
